(19) United States
(12) Patent Application Publication
(10) Pub. No.: US 2010/0123714 A1
(43) Pub. Date: May 20, 2010

(54) METHODS AND APPARATUS FOR COMBINED 4D PRESENTATION OF QUANTITATIVE REGIONAL PARAMETERS ON SURFACE RENDERING

(75) Inventors: Stian Langeland, Vestfold (NO); Stein Rabben, Sofiemyr (NO)

Correspondence Address: PETER VOGEL;GE HEALTHCARE, 20225 WATER TOWER BLVD., MAIL STOP W492, BROOKFIELD, WI, 53045, US

(73) Assignee: General Electric Company, Schenectady, NY (US)

(21) Appl. No.: 12/271,358

(22) Filed: Nov. 14, 2008

(51) Int. Cl. G06T 15/00; G06K 9/00

(52) U.S. Cl. 345/419; 382/128

(57) ABSTRACT

A method and apparatus for combined 4D presentation of quantitative regional parameters on a surface rendering is disclosed herewith. The method comprises: identifying a region of interest in a volumetric image data. Then, the following steps are iterated to produce a 4D surface rendering. The iterated steps include: tracking the region of interest of the volumetric image data to produce a displacement field. A color coded texture representing at least one quantitative regional parameter is applied on a surface defined by the volumetric data and the surface is being surface rendered with reference to the displacement field.

### FIELD OF THE INVENTION

This invention relates generally to methods and apparatus for presentation of quantitative measurements in a 4D rendering. The methods and apparatus are particularly useful in medical imaging.

### BACKGROUND OF INVENTION

New medical imaging technology permits regional quantitative 4D analysis of objects, such as the myocardium of a patient's heart. The regional quantitative 4D analysis provides detailed information on the motion and deformation of all material points in the object. However, with this new imaging technology, there is a need for new display methods and apparatuses. For example, there is a need for an intuitive display where a quantitative parameter is mapped directly to 3D anatomy. At least one known method for mapping parameters directly to 3D anatomy includes slicing of data and projecting the parameters onto a 2D image or projecting parametric data onto a surface model. This method simplifies the display of quantitative data, but does so at a cost of losing available detailed morphology information and visual perception of motion and deformation.

Thus, it will be beneficial to have a method and system for displaying regional quantitative parameters on a surface model of a 3D anatomy while retaining the visual perception of motion and deformation.

### BRIEF DESCRIPTION OF THE INVENTION

In one aspect, some embodiments of the present invention provide a method of visually enhancing display of motion in a 4D presentation of an object. The method comprises: identifying a region of interest at a point in time in a volumetric image data. Then, the following steps are iterated to produce a 4D surface rendering. The iterated steps include: tracking the region of interest of the volumetric image data to produce a displacement field; applying a texture on to a surface defined from the region of interest; and surface rendering the surface with reference to the displacement field.

In another aspect, some embodiments of the present invention provide a method of enhancing display of myocardial motion in a 3D surface rendering. The method comprises: obtaining a volumetric cardiac image; and identifying myocardial walls from the cardiac image. Then, the following steps are iterated to display myocardial motion in a 3D surface rendering. The iterated steps include: tracking the myocardial walls to identify the myocardial motion; identifying at least one regional quantitative parameter in relation to the myocardial motion; applying a texture to a surface of the myocardial walls with reference to the identified myocardial motion; superimposing the regional quantitative parameter into the texture in the form of color codes; and surface rendering the textured color coded surface.

In another aspect, some embodiments of the present invention provide a method for combined 4D presentation of quantitative measurements of an object. The method comprises: receiving a surface of a region of interest of a volumetric image of an object, the volumetric image being obtained by a first imaging system and aligning the surface obtained from the first imaging system with reference to the volumetric images obtained from a second imaging system. The following steps are iterated to display a combined 4D presentation of quantitative measurements of an object. The iterated steps includes: identifying a displacement field corresponding to motion of the region of interest from volumetric images of a similar object obtained by the second imaging system; applying color coded texture representing quantitative regional parameters onto the surface with reference to the displacement field; and surface rendering the surface and displaying the surface rendered image.

In another aspect, some embodiments of the present invention provide an apparatus that includes: a computer or processor, memory, and a display. The apparatus is configured to identify a region of interest of an object in volumetric image data. The apparatus further comprises: a tracking module configured to track the region of interest in an object to produce a displacement field; a quantitative analysis module configured to apply a color coded texture representing at least one regional quantitative parameter to surface of the volumetric image data; and a surface rendering module configured to render the surface from the volumetric image data to produce a surface rendering; wherein the tracking module, the quantitative analysis module and surface rendering module are configured to operate iteratively to thereby produce a visually enhanced 4D surface rendering representing at least one quantitative regional parameter.

In yet another aspect, some embodiments of the present invention provide a machine-readable medium or media having recorded thereon instructions configured to instruct an apparatus that comprises a computer or processor, memory, and a display. The media comprises: a routine for tracking an identified region of interest of a volumetric moving image data to produce a displacement field; a routine for applying a color coded texture representing at least one quantitative regional parameter onto a surface with reference to the displacement field, the surface being defined from the region of interest; and a routine for surface rendering the surface.

### BRIEF DESCRIPTION OF THE DRAWINGS

FIG. 1 is a flowchart illustrating a method of visually enhancing display of motion in a 4D presentation of an object as described in an embodiment of the invention;

FIG. 2 is a flowchart illustrating a method of enhancing display of myocardial motion in a 3D surface rendering as described in an embodiment of the invention;

FIG. 3 is a flowchart illustrating a method of displaying 4D presentation of quantitative measurements of an object as described in an embodiment of the invention;

FIG. 4 is a drawing illustrating a region of interest outlined in several cut planes of a volumetric image of an object as described in an embodiment of the invention;

FIG. 5 is a drawing illustrating a displacement field as described in an embodiment of the invention;

FIG. 6 is block diagram of an apparatus capable of displaying visually enhanced display of motion in a 4D presentation of an object as described in an embodiment of the invention;

FIG. 7 is a block diagram of a processor that is capable of generating visually enhanced motion in a 4D presentation of an object as described in an embodiment of the invention;

FIGS. 8A to 8C respectively illustrate a surface model without texture, a surface model with texture, and a surface model with texture and color codes showing the difference in the visual appreciation by applying texture and color coding to the surface;

FIGS. 9A to 9C respectively illustrate a cardiac ventricular surface model with artificial texture and color-coding at three different stages of a cardiac cycle; and

FIG. 10 illustrates a ventricular surface rendering resulted by a method described in various embodiments of the invention.

### DETAILED DESCRIPTION OF THE INVENTION

The foregoing summary, as well as the following detailed description of certain embodiments of the present invention, will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (e.g., processors or memories) may be implemented in a single piece of hardware (e.g., a general purpose signal processor or a block of random access memory, hard disk, or the like). Similarly, the programs may be stand alone programs, may be incorporated as subroutines in an operating system, may be functions in an installed software package, and the like. It should be understood that the various embodiments are not limited to the arrangements and instrumentality shown in the drawings.

As used herein, an element or step recited in the singular and proceeded with the word “a” or “an” should be understood as not excluding plural elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property. Moreover, the terms “computer” and “processor” are used interchangeably herein to refer to either specialized hardware to perform digital signal processing, control, data manipulation, and/or calculations, or a general purpose computer that can be programmed to perform the same functions and/or adapted to interface with external digital signals. The phrases “computer or processor” and “processor or computer” are therefore intended to have equal scope with either of the individual terms and are not intended to imply a dichotomy between the two terms.

Technical effects of embodiments of the present invention include providing an improved quantitative regional parameters display. Furthermore, some embodiments of the present invention facilitate using a texture on the surface of the image to generate a realistic view of the surface rendering. Also in some embodiments, quantitative regional parameters are identified and are superimposed on the texture as color codes. Thus surface rendering superimposed with a color-coded texture, representing the quantitative regional parameters, provides an enhanced display of 4D surface rendering.

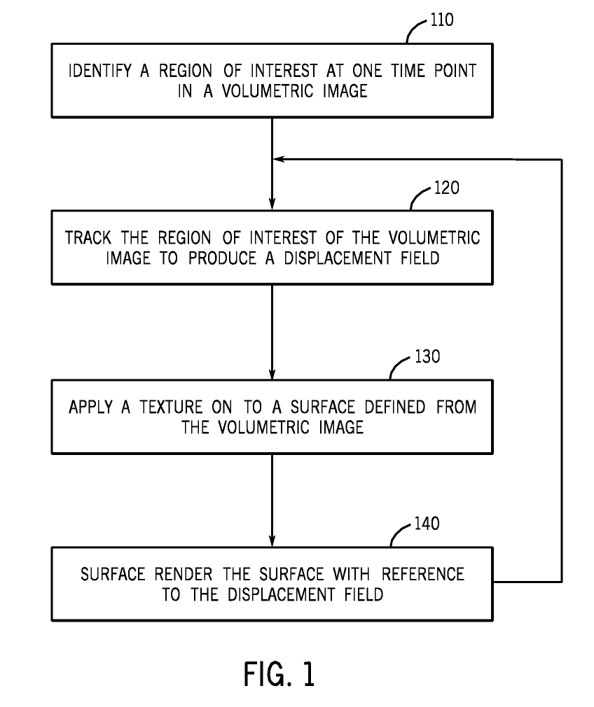

FIG. 1 is a flowchart illustrating a method of visually enhancing display of motion in a 4D presentation of an object as described in an embodiment of the invention. At step 110, a region of interest is identified in a volumetric image at one time point. In an example, the volumetric image may be a sequence of volumetric images of a moving object including a moving organ. The term volumetric image or volumetric image data conveys a volumetric image sequence representing motion of the object. The volumetric image can be obtained using ultrasound imaging, magnetic resonance imaging, 4D computed tomography imaging, or any other imaging technique. The region of interest from a volumetric image may be identified by using various algorithms or devices used in the industry. The clinician can select the region of interest based on his requirement. However, the region of interest can be identified manually or automatically, for example by surface detection methods. Once the region of interest is selected, the following steps 120 to 140 can be iterated for available time steps in the volumetric image sequence. At step 120, the region of interest is tracked to produce a displacement field. The displacement field represents the motion of the selected region of interest. A suitable tracking technique may be used to estimate the displacement field. At step 130, a texture is applied to a surface, the surface being identified from the volumetric image. The texture is applied on the surface with reference to the displacement field. The coordinates of the surface and texture are mapped with reference to the displacement field, so that the texture also moves along with the surface. In an embodiment, the surface may be obtained from a different source and the texture may be applied on to the surface At step 140, the surface along with the texture is surface rendered with reference to the displacement field. The surface rendering of the image with reference to the displacement field may be achieved by various existing methods.

In an embodiment, at least one quantitative regional parameter may be identified while tracking the region of interest. Some of the examples of the quantitative regional parameters include velocity, stress, strain, displacement etc. The quantitative regional parameters may vary based on the motion of the region of interest. For example, in a cardiac image, strain in the cardiac walls during different stages of cardiac cycle will be different. The quantitative regional parameters may be estimated at different stages and may be represented as color codes, so that these quantitative regional parameters can be identified easily. Thus, in some of the embodiments, the quantitative regional parameters are represented as color codes and the same is superimposed onto the texture or to the surface rendering. It is to be noted that the color codes may be superimposed onto the texture or the texture may be provided on the color codes. Thus, the workflow generates a 4D surface rendered image with texture having color codes representing at least one quantitative regional parameter.

In an embodiment, different textures, such as texture in the form of speckle pattern, texture looking like organ tissue, and texture based on renderings from any imaging modality, may be used. The imaging modality could include any imaging modality but need not be limited to modality using, which initially the volumetric images are acquired.

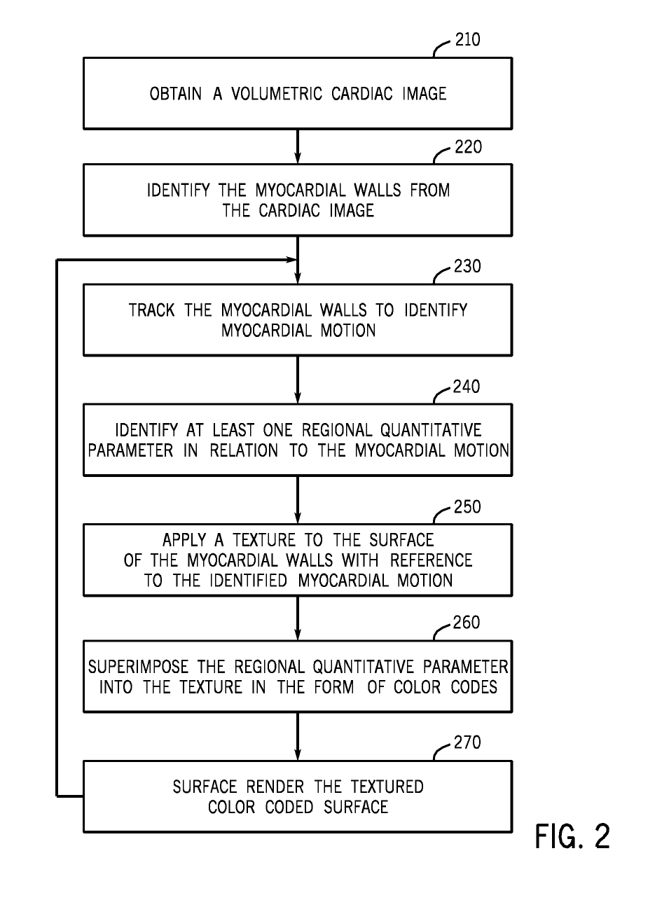

FIG. 2 is a flowchart illustrating a method of enhancing display of myocardial motion in a 3D surface rendering as described in an embodiment of the invention. At step 210, a volumetric cardiac image is obtained. The image may be obtained using any imaging system. In an example, the image is a cardiac ultrasound volumetric image. At step 220, myocardial walls are identified from the cardiac image. At step 230, the myocardial walls are tracked. This is achieved by obtaining a displacement field representing the motion of the myocardial walls. The displacement field can be estimated using a suitable tracking method. At step 240, at least one regional quantitative parameter such as strain, stress, velocity, and/or displacement etc., may be identified with reference to the motion of the myocardial wall. The regional quantitative parameter, such as strain in the myocardial wall, will be different at different stages of the cardiac cycle due to the motion of the myocardial wall. At step 250 a texture is applied on the surface of the image. The surface may be identified from a volumetric object boundary in the volumetric image. The surface coordinates representing the surface may be identified with reference to the displacement field. The surface coordinates are mapped with the texture using the displacement field. The mapping is done such that the texture moves along with the surface, so that the texture looks superimposed on the surface. This enhances the visual perception of motion of the surface. At step 260, at least one quantitative regional parameter, obtained by step 240, is superimposed onto the texture as color codes. The color codes are superimposed onto the texture with reference to the displacement field. At step 270, surface rendering is performed to generate an enhanced 4D image data representing quantitative regional parameters in the form of color codes. The steps 230 to 270 are repeated for each time step in the 4D image data until a dynamic surface rendering with improved visual perception of motion and deformation is obtained.

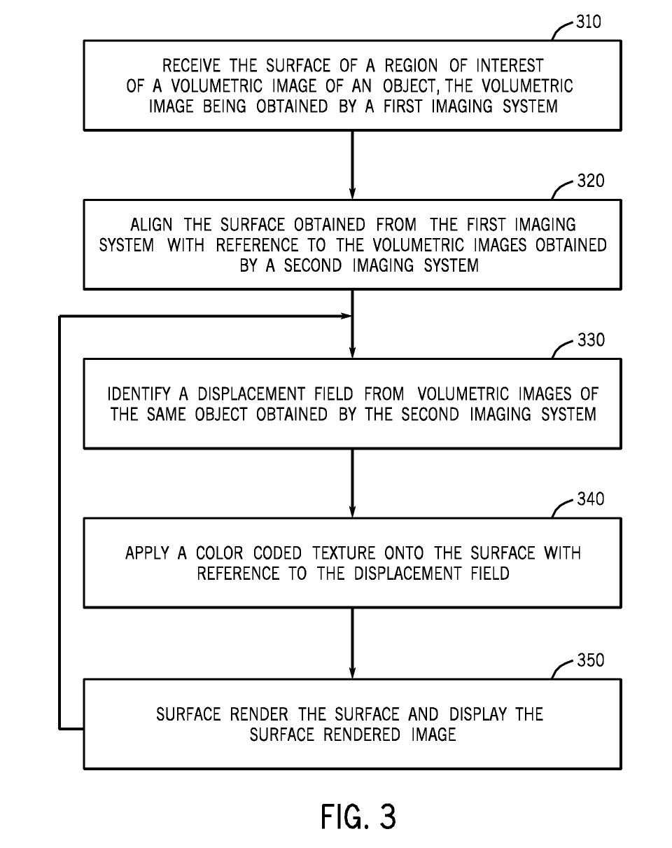

FIG. 3 is a flowchart illustrating a method of displaying 4D presentation of quantitative measurements of an object as described in an embodiment of the invention. At step 310, surface coordinates of a region of interest in a volumetric image are obtained. This could be obtained from a volumetric image acquired by a first imaging system. The first imaging system may acquire the image and store it in an image-storing device. The region of interest and corresponding surface coordinates may be identified later. At step 320, the surface obtained from the first imaging system is aligned with reference to a volumetric image of a similar object obtained by a second imaging system. A same or similar region of interest may be selected. At step 330, a displacement field representing motion of the region of interest in the image of a similar object may be obtained from the volumetric images obtained by the second imaging system. The displacement field may be obtained by tracking the selected region of interest using a suitable tracking method. This displacement field represents the motion of the region of interest. Also by tracking the region of interest, at least one quantitative regional parameter, such as strain, stress, velocity, displacement, etc. in the region of interest due to motion may be identified. At step 340, a color-coded texture representing at least one quantitative regional parameter is super imposed onto the surface obtained by the first imaging system, with reference to the displacement field. At step 350, the color-coded and textured surface is rendered and an enhanced surface rendering is obtained. The steps 330-350 are repeated for each time step in the 4D image data until a dynamic surface rendering with improved visual perception of motion and deformation is obtained.

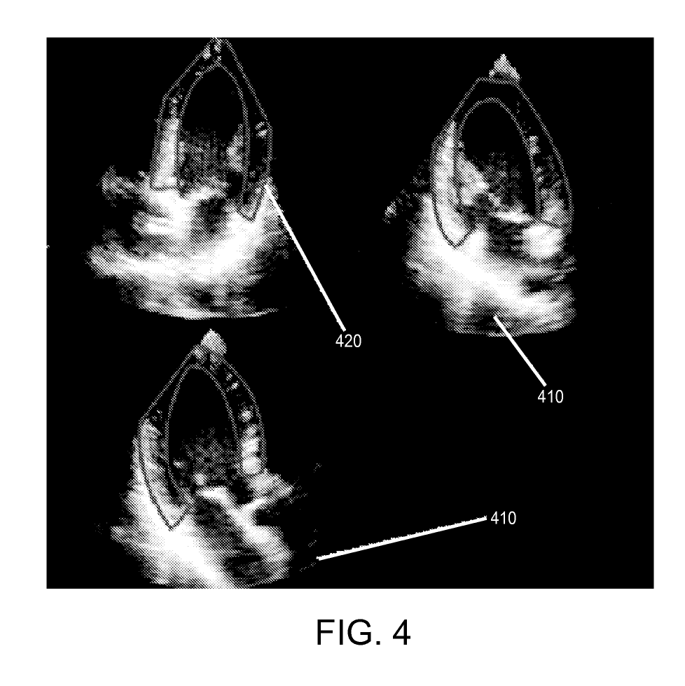

FIG. 4 is a drawing illustrating an outline of a region of interest 420 defined from the boundary of a volumetric object 410. In the image shown, the images are cross sections of a volumetric echocardiographic image of a heart.

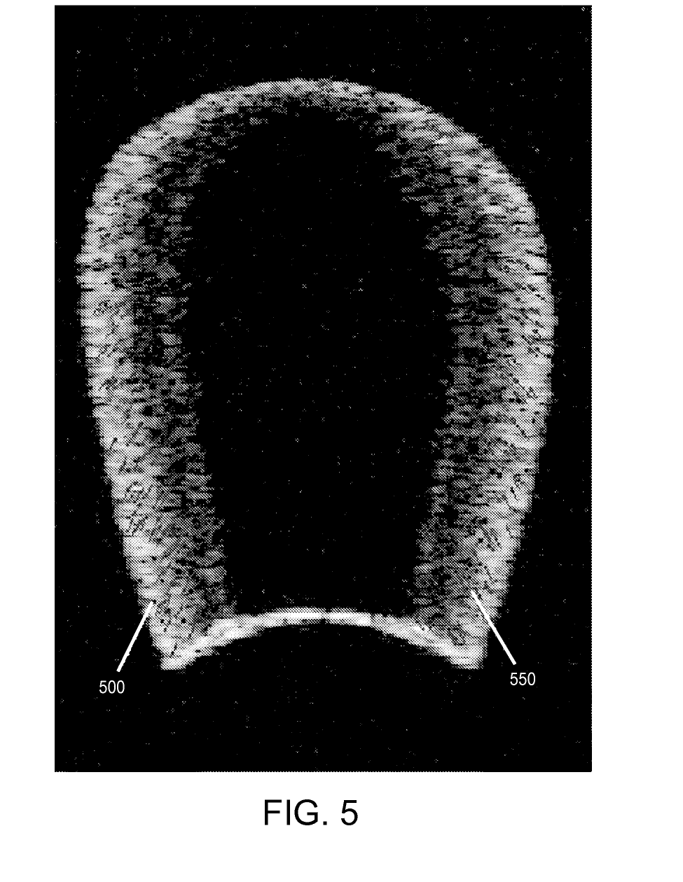

FIG. 5 is a drawing illustrating a displacement field 550. The displacement field 550 can be estimated using a suitable tracking method. The displacement field 550 is shown here on a 2D slice of a 3D image data 500 for simplicity.

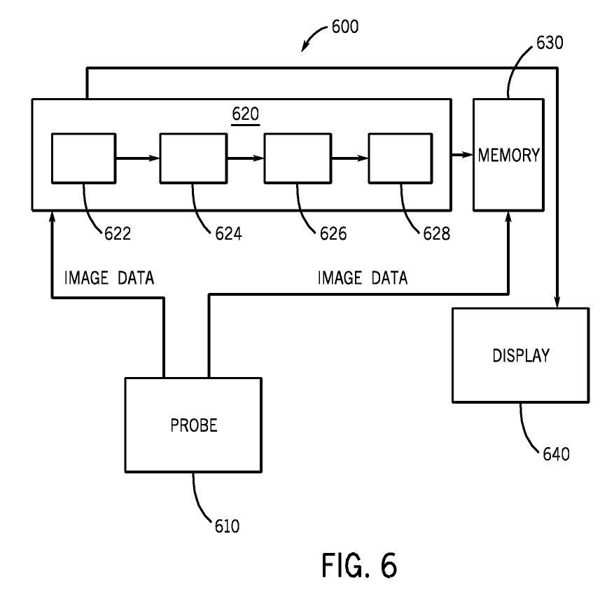

FIG. 6 is block diagram of an apparatus 600 capable of displaying visually enhanced display of motion in a 4D presentation of an object as described in an embodiment of the invention. The apparatus 600 is configured to have a probe or transducer 610 configured to acquire raw medical image data. The apparatus 600 may acquire volumetric images of a moving object and store it in an image-storing device. In some embodiments, the probe 610 is an ultrasound transducer, and the apparatus 600 is an ultrasound imaging apparatus. A memory 630 stores acquired raw image data, which may be processed by a processor 620 in some embodiments of the present invention. A display 640 (e.g., an internal display) is also provided and is configured to display a medical image in various forms, such as surface renderings or volume renderings.

To display a medical image obtained using the probe 610, the processor 620 is provided with a software or firmware memory 622 containing instructions to perform image-processing techniques on the acquired raw medical image data. Although shown separately in FIG. 6, it is not required that the software memory 622 and memory 630 be physically separate memories. Dedicated hardware may be used instead of software and/or firmware for performing image processing, or a combination of dedicated hardware and software, or software in combination with a general purpose processor, or a digital signal processor. Once the requirements for such software and/or hardware and/or dedicated hardware are gained from an understanding of the descriptions of embodiments of the invention contained herein, the choice of any particular implementation may be left to a hardware engineer and/or software engineer. However, any dedicated and/or special purpose hardware or special purpose processor is considered subsumed in the block labeled processor 620.

Software or firmware memory 622 can comprise a read only memory (ROM), random access memory (RAM), a miniature hard drive, a flash memory card, or any kind of device (or devices) configured to read instructions from a machine-readable medium or media. The instructions contained in software or firmware memory 622 further include instructions to produce a medical image of suitable resolution for display on display 640 and/or to send acquired raw or scan converted image data stored in a data memory 630 to an external device (not shown), such as a computer. The image data may be sent from the processor 620 to external device via a wired or wireless network (or direct connection, for example, via a serial or parallel cable or USB port) under control of the processor 620 and a user interface. In some embodiments, the external device may be a computer or a workstation having a display and memory. The user interface (which may also include display 640) also receives image data from a user and supplies the data to the processor 620. In some embodiments, display 640 may include an x-y input, such as a touch-sensitive surface and a stylus (not shown), to facilitate user input.

In an embodiment, the medical imaging system may be configured as a miniaturized device. As used herein, “miniaturized” means that the medical imaging system is a handheld or hand-carried device or is configured to be carried in a person's hand, briefcase-sized case, or backpack. For example, a medical imaging system may be a hand-carried device having a size of a typical laptop computer. In an example, the medical imaging system may be an ultrasound imaging system.

Embodiments of the present invention can comprise software or firmware instructing a computer to perform certain actions. Some embodiments of the present invention comprise stand-alone workstation computers that include memory, a display, and a processor. The workstation may also include a user input interface (which may include, for example, a mouse, a touch screen and stylus, a keyboard with cursor keys, or combinations thereof). The memory may include, for example, random access memory (RAM), flash memory, or read-only memory. For purposes of simplicity, devices that can read and/or write media on which computer programs are recorded are also included within the scope of the term “memory.” A non-exhaustive list of media that can be read with such a suitable device includes CDs, CD-RWs, DVDs of all types, magnetic media (including floppy disks, tape, and hard drives), flash memory in the form of sticks, cards, and other forms, ROMs, etc., and combinations thereof.

Some embodiments of the present invention may be incorporated into a medical imaging apparatus, such as ultrasound imaging system 600 of FIG. 6. In correspondence with a stand-alone workstation, the “computer” can be considered as the apparatus itself, or at least a portion of the components therein. For example, the processor 620 may comprise a general purpose processor with memory, or a separate processor and/or memory may be provided. Display 640 corresponds to the display of the workstation, while the user interface corresponds to the user interface of the workstation. Whether a stand-alone workstation or an imaging apparatus is used, software and/or firmware (hereinafter referred to generically as “software”) can be used to instruct the computer to perform the inventive combination of actions described herein. Portions of the software may have specific functions, and these portions are herein referred to as “modules” or “software modules.” However, in some embodiments, these modules may comprise one or more electronic hardware components or special-purpose hardware components that may be configured to perform the same purpose as the software module or to aid in the performance of the software module. Thus, a “module” may also refer to hardware or a combination of hardware and software performing a function.

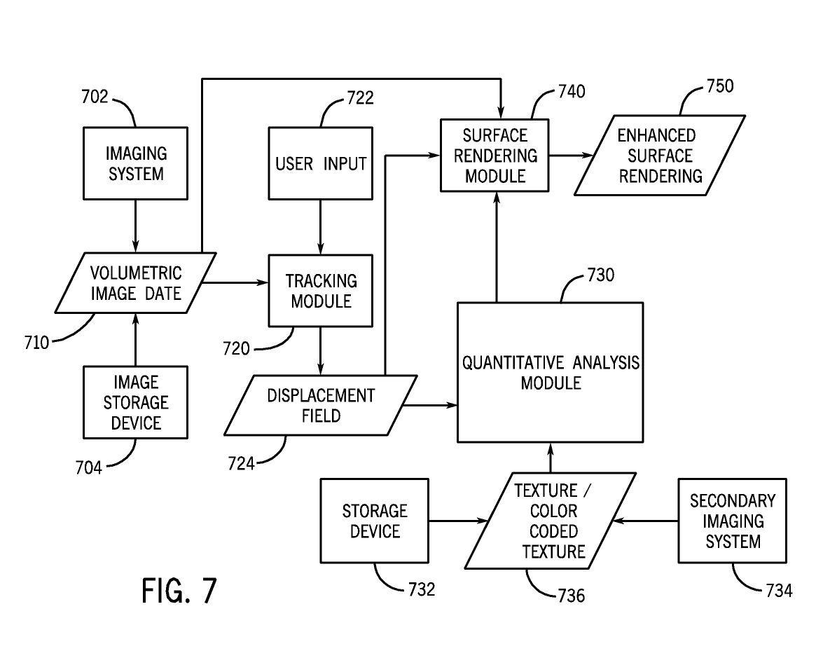

In some embodiments of the present invention, the processor 620 includes a module (not shown) to identify the region of interest in volumetric image of an object. Alternately, the apparatus 600 may be configured to identify the region of interest. The region of interest may be identified manually or automatically. The processor 620 further includes modules that may be implemented within the processor or computer by a stored program and/or within special purpose hardware. These modules include a tracking module 624 configured to track a region of interest in image data to produce a displacement field. Also included is a quantitative analysis module 626 configured to extract at least one quantitative regional parameter from the displacement field and to apply the quantitative regional parameter or parameters as color-coded data onto the surface or surface rendering. A surface rendering module 628 is provided in association with the quantitative analysis module 626 and is configured to render the color coded surface to produce a visually enhanced surface rendering. The display 640 is configured to display the enhanced surface rendering. The tracking module 624, the quantitative analysis module 626, and the surface rendering module 628 are configured to operate iteratively to thereby produce an enhanced surface rendering displayed with at least one quantitative regional parameter embedded as color codes on the surface. Different modules referred shall be explained in detail with reference to FIG. 7.

FIG. 7 is a block diagram of a processor that is capable of generating visually enhanced display of motion in a 4D presentation of an object as described in an embodiment of the invention. Volumetric image data 710 is obtained from an imaging system 702 or from an image storage device 704. User input 722 and volumetric image data 710 are provided to a tracking module 720, which tracks the region of interest to determine a displacement field 724. The user input 722 is not necessarily required for all embodiments of the present invention, and some embodiments need not provide any functionality for gathering user input 722, optionally or otherwise. The user input 722, when provided, includes initialization data, and could include other instruction stored in a software memory such as 622 (see FIG. 6). The tracking module 720 can utilize any known method that can be used to track an object in image data 710 and produce a displacement field 724. In an embodiment, the object may be a heart and the region of interest may be myocardial walls. The tracking module 720 may be a wall tracking module configured to track the walls and produce the displacement field 724 within the walls.

The displacement field 724 is provided to a quantitative analysis module 730. The quantitative analysis module 730 extracts at least one quantitative parameter from the displacement field 724. The quantitative analysis module 730 is further configured to convert the identified quantitative regional parameters into color codes and superimpose the same onto a texture 736. The texture 736 could be provided from a storage device 732 or a secondary imaging system 734. The color coded texture is superimposed onto the surface or to a surface rendering.

The volumetric image data 710, along with the displacement field 724, is provided to a surface rendering module 740. The surface rendering module 740 is further provided with a color coded texture. Alternately, the color-coded texture may be superimposed on to the surface identified from the volumetric image data 710, and the surface superimposed with the color coded texture may be fed to the surface rendering module 740 along with the displacement field 724. The volumetric image data 710 may also be provided from the image system or from the image-storing device. The volumetric image data 710 as used herein, may comprise any one or more of image data, synthetic image data, a secondary (or tertiary, etc.) modality of image data (for example, a CT or MRI image), and a cardiac model, or any other volumetric anatomical model. The volumetric image data 710, along with the displacement field 724, and the color coded texture is surface rendered by the surface rendering module 740 and an enhanced surface rendering 750 with at least one regional quantitative parameter superimposed on a texture as the color code is produced.

It should be noted that configurations of the present invention are not limited to cardiac applications or medical applications, in which case the data 710 to be displayed would be data representative of a different object having different displacement characteristics.

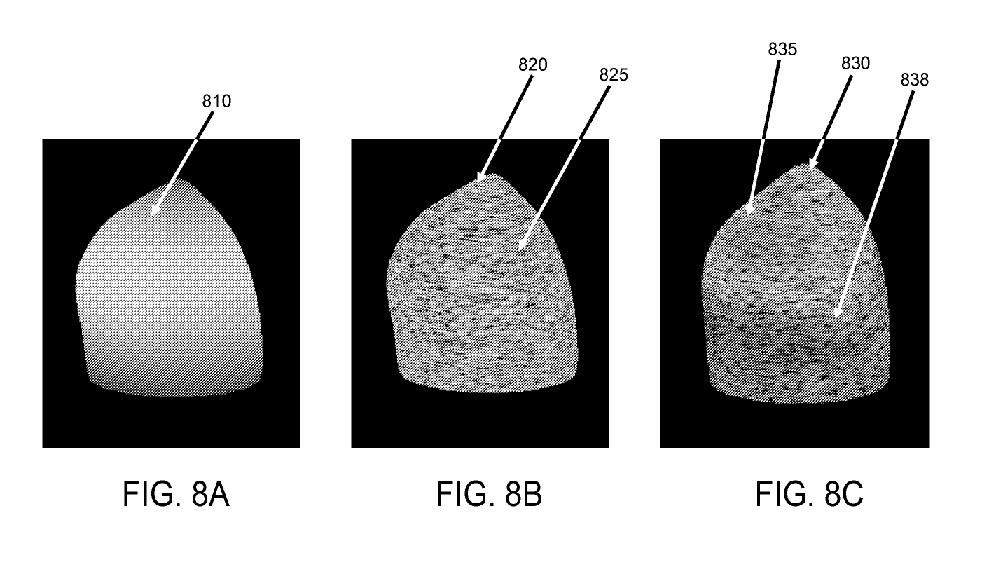

FIGS. 8A to 8C respectively illustrate a surface rendering without texture, with texture, and with color coded texture showing the difference in the visual appreciation by applying texture and color-coding. A 2D view of a surface rendering model of a normal cardiac image 810 is shown in FIG. 8A. The longitudinal strain due to myocardial motion over the myocardial walls is not visible and cannot be identified from FIG. 8A. FIG. 8B illustrates a surface rendering of the image 810 with a texture 825 applied on the surface of the image. The surface rendering with texture 820 enhances the visual perception of the motion and deformation of the volumetric object. In FIG. 8C, the 2D image 810 is applied with a texture 835, and the texture 835 is superimposed with color codes 838 representing the longitudinal strain. Thus. a 2D cardiac image 810 is displayed as a surface rendering with a texture having color-codes superimposed on it, shown as 830.

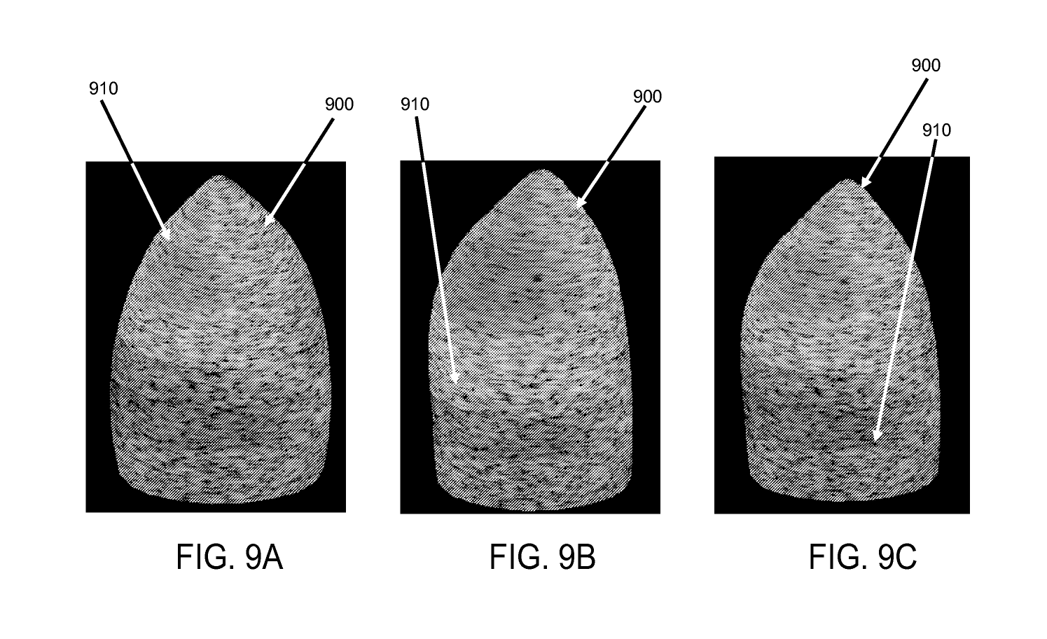

FIGS. 9A to 9C respectively illustrate a cardiac ventricular surface model 900 with artificial texture and color-coding at three different stages of a cardiac cycle. The figures illustrate the strain on myocardial walls during a cardiac cycle. FIG. 9A shows the end of the diastole stage, the expanded stage of heart in a cardiac cycle. The regional quantitative parameter longitudinal strain 910 is represented in different colors. A speckle like texture is applied on the surface of the image, and onto the surface, the colors representing the longitudinal strain are superimposed. FIG. 9B shows a mid systole stage, while the heart is contracting, in a cardiac cycle, and FIG. 9C shows the systole stage, the contracted stage of heart, of the cardiac cycle. From the figures, it is clear that the perception of the deformation along the myocardial wall is highly enhanced by adding texture and color-coding. And this helps a clinician visualize tangential motion and deformation of cardiac walls. It also improves visual perception of rotation and torsion.

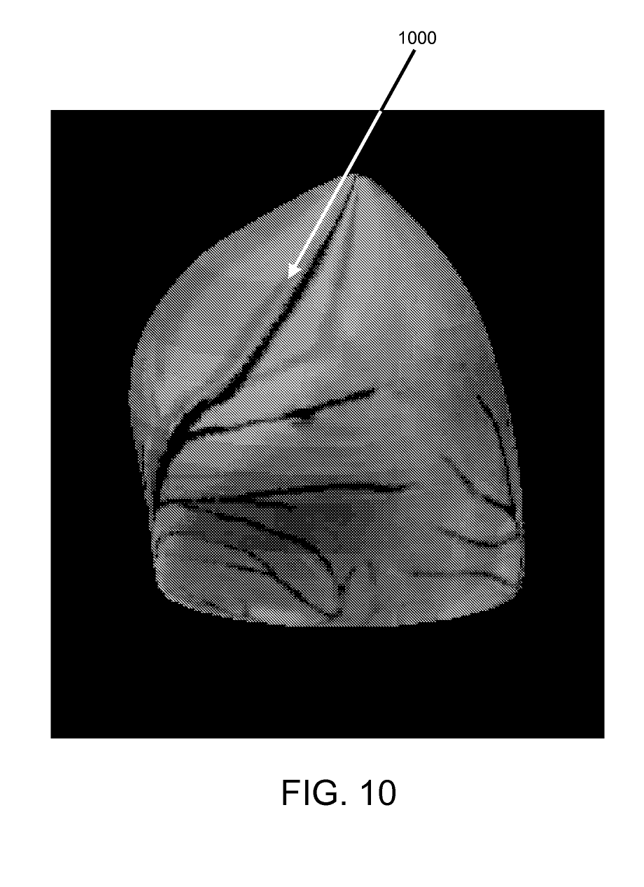

FIG. 10 illustrates a ventricular surface rendering 1000 resulted by a method described in various embodiments of the invention. A more realistic texture has been superimposed on the surface in combination with color coding of quantitative information.

In yet other embodiments of the present invention, a machine readable medium or media may include, but is not limited to, magnetic disks and diskettes, optical disks and diskettes, and/or ROM, flash ROM, and/or battery backed RAM, or any other suitable magnetic, optical, or electronic medium or media. The medium (or media) has recorded thereon instructions configured to instruct an apparatus 600 that includes a computer or processor 620, memory 622, 630, and a display 640. The instructions include instructions for tracking an identified region of interest of a volumetric moving image data to produce a displacement field. The instruction further include instructions to apply a color coded texture representing quantitative regional parameters onto a surface, defined from the volumetric image, with reference to the displacement field and surface rendering the surface. The instructions further include instructions to repeat the above-mentioned steps a plurality of times. The repeated steps further include instructions for identifying quantitative regional parameters from displacement of the 4D data. The repetition thus produces a 4D-enhanced surface rendering with at least one quantitative regional parameter superimposed on a texture provided on the surface of the rendering. The result of this can be shown in FIG. 9C and FIG. 10.

It will thus be appreciated that embodiments of the present invention provide an intuitive display of at least one quantitative parameter represented as color codes being mapped on to a surface rendering of an object. Embodiments of the present invention are particularly useful in analyzing the myocardial motion in detail.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of visually enhancing display of motion in a 4D presentation of an object, comprising:
identifying a region of interest at a point in time in a volumetric image;
repeating the following steps a plurality of times:
tracking the region of interest of the volumetric image to produce a displacement field;
applying a texture on to a surface defined from the volumetric image; and
surface rendering the surface with reference to the displacement field.

2. The method as claimed in claim 1, wherein the step of identifying the region of interest comprises: detecting region of interest manually or automatically.

3 The method as claimed in claim 1, wherein said volumetric image includes a moving volumetric image from any imaging modality.

4. The method as claimed in claim 3, wherein the imaging modality includes: ultrasound imaging, magnetic resonance imaging, and three-dimensional computed tomography imaging.

5. The method as claimed in claim 1, wherein the step of tracking comprises: identifying the displacement field representing motion of the region of interest.

6. The method as claimed in claim 5, wherein the step of tracking further comprises: identifying at least one regional quantitative parameter in relation to the displacement field.

7. The method as claimed in claim 6, wherein the method further comprises: superimposing the regional quantitative parameters into the texture in the form of color codes.

8. The method as claimed in claim 7, wherein the regional quantitative parameters include: stress, strain, velocity, and displacement.

9. The method as claimed in claim 1, wherein the step of surface rendering comprises: creating a surface of the region of interest wherein the surface coordinates movement according to the displacement field.

10. The method as claimed in claim 9, wherein the step of applying texture comprises: mapping texture coordinates with the surface causing the texture to move according to the displacement field.

11. The method as claimed in claim 1, wherein the texture includes: texture in the form of speckle pattern, texture looking like organ tissue, and texture based on renderings from any imaging modality.

12. A method of enhancing display of myocardial motion in a 3D surface rendering, comprising:
obtaining a volumetric cardiac image;
identifying myocardial walls from the cardiac image;
repeating the following steps a plurality of times:
tracking the myocardial walls to identify the myocardial motion;
identifying at least one regional quantitative parameter in relation to the myocardial motion;
applying a texture to a surface of the myocardial walls with reference to the identified myocardial motion;
superimposing the regional quantitative parameter into the texture in the form of color codes; and
surface rendering the textured color coded surface.

13. The method as claimed in claim 12, wherein the step of obtaining a volumetric cardiac image comprises: obtaining the cardiac image from an imaging system or from an image storage device.

14. The method as claimed in claim 12, wherein the regional quantitative parameters include: stress, strain, velocity, and displacement.

15. The method as claimed in claim 12, wherein the texture includes: texture in the form of speckle pattern, texture looking like organ tissue, and texture based on renderings from any imaging modality.

16. A method for combined 4D presentation of quantitative measurements of an object, comprising:
receiving a surface of a region of interest of a volumetric image of an object, the volumetric image being obtained by a first imaging system;
aligning the surface obtained from the first imaging system with reference to the volumetric images obtained from a second imaging system; repeating the following steps a plurality of times:
identifying a displacement field corresponding to motion of the region of interest from volumetric images of a similar object obtained by the second imaging system;
applying color coded texture representing at least one quantitative regional parameter onto the surface with reference to the displacement field; and
surface rendering the surface and displaying the surface rendered image.

17. The method as claimed in claim 16, wherein the first and second imaging system includes: an ultrasound imaging system, a magnetic resonance imaging system, and a computed tomography imaging system.

18. The method as claimed in claim 16, wherein the image is a volumetric cardiac image.

19. The method as claimed in claim 16, wherein the region of interest is myocardial walls.

20. The method as claimed in claim 16, wherein the step of applying color coded texture comprises: representing the quantitative regional parameters defined by motion of the region of interest as color codes and applying the same onto the surface with reference to the displacement field.

21. An apparatus comprising a computer or processor, memory, and a display, said apparatus configured to: identify a region of interest of an object in volumetric image data; said apparatus further including:
a tracking module configured to track the region of interest in an object to produce a displacement field;
a quantitative analysis module configured to apply a color coded texture representing at least one quantitative regional parameter to a surface of the volumetric image data; and
a surface rendering module configured to render the surface from the volumetric image data to produce a surface rendering;
wherein the tracking module, the quantitative analysis module and surface rendering module are configured to operate iteratively to thereby produce a visually enhanced 4D surface rendering representing at least one quantitative regional parameter.

22. The apparatus as claimed in claim 21, wherein the quantitative analysis module is further configured to identify at least one regional quantitative parameter with reference to the displacement field and superimpose the same as color codes onto the texture.

23. The apparatus as claimed in claim 21, wherein the apparatus is an ultrasound imaging apparatus further comprising an ultrasound probe, the apparatus is configured to obtain 4D image data using the ultrasound probe, and the 4D image data is ultrasound image data.

24. A machine readable medium or media having recorded thereon instructions configured to instruct an apparatus comprising a computer or processor, memory, and a display, comprising:
a routine for tracking an identified region of interest of a volumetric moving image data to produce a displacement field;
a routine for applying a color coded texture representing at least one quantitative regional parameter onto a surface with reference to the displacement field, the surface being defined from the volumetric moving image data; and
a routine for surface rendering the surface.

25. The medium as claimed in claim 24, wherein the routine for applying color coded texture comprises: a routine for identifying quantitative regional parameters from the displacement field of the volumetric moving image data.
